(19) United States
(12) Patent Application Publication
(10) Pub. No.: US 2026/0252753 A1
(43) Pub. Date: Aug. 27, 2026

(54) SYSTEMS AND METHODS FOR DEVICE DESIGN AND MANUFACTURING PROCESS

(71) Applicants: THE UNITED STATES GOVERNMENT AS REPRESENTED BY THE DEPARTMENT OF VETERANS AFFAIRS, Washington, DC (US); UNIVERSITY OF PITTSBURGH - OF THE COMMONWEALTH SYSTEM OF HIGHER EDUCATION, Pittsburgh, PA (US)

(72) Inventors: Rory A. Cooper, Pittsburgh, PA (US); Garrett G. Grindle, Pittsburgh, PA (US); Ian Eckstein, Pittsburgh, PA (US); Joshua Kanode, Pittsburgh, PA (US); Jonathan Duvall, Pittsburgh, PA (US); Rosemarie Cooper, Pittsburgh, PA (US); Jessica Steinberg, Pittsburgh, PA (US); Benjamin Gebrosky, Pittsburgh, PA (US)

(21) Appl. No.: 18/992,124

(22) PCT Filed: Jul. 10, 2023
(86) PCT No.: PCT/US2023/027233

§ 371 Date: Jan. 7, 2025

Related U.S. Application Data
(60) Provisional application No. 63/359,603, filed on Jul. 8, 2022.

(51) Int. Cl. G06F 30/15

(52) U.S. Cl. CPC G06F 30/15

(57) ABSTRACT

Systems, methods, and apparatuses for preparing a device, such as a wheelchair, for assembly are provided. Anatomical measurements of an intended user of the device may be received. Frame properties for the device may be determined. The frame properties may be determined based on the one or more anatomical measurements of the user. A material for constructing part or all of the frame of the device may be determined. The material may be determined based on the frame properties. One or more parts for the frame may be converted from a three-dimensional shape to a two-dimensional part shape. A nesting arrangement for the parts of the device to be cut from the material may be determined on a sheet of the material. A bending order for bending the parts may also be determined. The parts of the device may be cut from the sheet material, bent, and assembled.

### CROSS REFERENCE TO RELATED PATENT APPLICATIONS

This application claims priority to and the benefit of U.S. Provisional Patent Application No. 63/359,603 filed Jul. 8, 2022, the entire contents of which are hereby incorporated herein by reference for all purposes.

### BACKGROUND

Manual wheelchairs provide essential means of mobility for millions of people with disabilities. In 1932, Herbert Everest and Harry Jennings invented the first practical wheelchair based on using tubular steel. Everest and Jennings concepts remain the basis for many wheelchairs in use today.

In the early 1980's, designers, and inventors, most of whom were people with disabilities themselves, began to create new tubular designs for manual wheelchairs. Many of these new designs were based upon the designer or inventor's desire for higher performance. The desire for higher performance wheelchairs was often driven by the desire to participate in sports and have greater mobility. This resulted in a new era of manual wheelchair design based on steel, aluminum, and/or titanium tubing. Many of the innovations were directed towards tubular ultra-lightweight rigid frames and quick-release axles.

Since that time there has been a nearly continuous evolution of manual wheelchair designs to facilitate participation in more activities, such as racing, rugby, basketball, standing, and more. However, previously, there have been no manual wheelchairs (or even powered wheelchairs) based on Kirigami principles.

### SUMMARY

It is to be understood that both the following general description and the following detailed description are exemplary and explanatory only and are not restrictive. Methods, systems, and apparatuses systems for device design, such as wheelchair design, and manufacturing are described.

In one example, a method for preparing a device for manufacturing may include receiving one or more anatomical measurements of a user that is expected to use the device. Frame properties for the device may be determined. For example, the frame properties may be determined based on the one or more anatomical measurements of the user. A material for constructing parts or all of the frame of the device may be determined. For example, the material may be determined based on the frame properties. One or more parts for the frame may be converted from a three-dimensional shape to a two-dimensional part shape. A nesting arrangement for the parts of the device to be cut from the material may be determined on a sheet of the material. For example, the nesting arrangement may be determined based on two-dimensional part shape for the one or more parts of the frame to be cut from the material.

In another example, a method for preparing a device for manufacturing may include receiving a solid model of a parameterized design for a device. For example, the solid model of the device may include solid model design for each of the parts of the device. The solid model design for all or a portion of the parts may be converted to a two-dimensional geometry. The parts may be converted to the two-dimensional geometry for nesting and cutting of those parts from a sheet of material. A nesting pattern comprising one or more of the parts of the device may be generated for overlay on a representation of a sheet of the material. A cutting path for cutting the one or more parts from the sheet of material may be determined. For example, the cutting path may be determined in order to minimize the warpage to one or more of the parts of the device. For example, the cutting may be determined in order to minimize the damage to one or more of the parts of the device. A bending order for one or more of the parts may be determined. For example, the bending order may be based on the difference between the three-dimensional solid model design of the part and the two-dimensional geometry that the part was converted to for cutting from the sheet of material.

In another example, one or more non-transitory, computer-readable media may be provided. The computer-readable media may include processor-executable instructions. The processor-executable instructions may be executed by one or more processors. The instructions may cause the one or more processors to receive one or more anatomical measurements of a user that is expected to use a device. The instructions may cause the one or more processors to determine frame properties. For example, the frame properties may be determined based on the one or more anatomical measurements of the user. The instructions may cause the one or more processors to determine a material for constructing parts or all of the frame of the device. For example, the material may be determined based on the frame properties. The instructions may cause the one or more processors to convert one or more parts for the frame from a three-dimensional shape to a two-dimensional part shape. The instructions may cause the one or more processors to determine a nesting arrangement for the parts of the device to be cut from the sheet of material. For example, the nesting arrangement may be determined based on two-dimensional part shape for the one or more parts of the frame to be cut from the material.

### BRIEF DESCRIPTION OF THE DRAWINGS

For a more complete understanding of the present disclosure and certain features thereof, references is now made to the following description, in conjunction with the accompanying figures briefly described as follows.

FIG. 1 is an example system for designing and constructing a Kirigami-inspired wheelchair;

FIG. 2 is a flowchart of an example method for creating a Kirigami-inspired wheelchair;

FIG. 3 is a flowchart of an example method for creating a Kirigami-inspired device;

FIG. 4 is a flowchart of an example method for creating a Kirigami-inspired device;

FIG. 5 is a top plan view of an example seat part for a Kirigami-inspired wheelchair;

FIG. 6 is a side elevation view of the example seat part of FIG. 5;

FIG. 7 is a partial side elevation view of an example Kirigami-inspired wheelchair;

FIG. 8 is a view of an example side frame part for a Kirigami-inspired wheelchair;

FIG. 9 is a partial front elevation view of an example support structure for the seat part for a Kirigami-inspired wheelchair;

FIGS. 10A-B are example before and after views of a portion of the support structure of FIG. 9 having apertures and a slot added for footrest adjustability;

FIGS. 11-12 are example footrest parts for a Kirigami-inspired wheelchair;

FIGS. 13A-B are example before and after views of a seat-back part for a Kirigami-inspired wheelchair with cut-outs to reduce an overall weight;

FIG. 14A is an example three-dimensional depiction of a frame for a Kirigami-inspired wheelchair;

FIG. 14B is an example two-dimensional flattened depiction of the frame of FIG. 14A;

FIG. 15 is a view of an example cutting device cutting a sheet of material for parts of the Kirigami-inspired wheelchair;

FIG. 16 is a view of an example bending device for bending parts cut from the sheet of material for the Kirigami-inspired wheelchair;

FIG. 17 is a front elevation view of an example Kirigami-inspired wheelchair;

FIG. 18 is a view of an example nesting pattern of parts on a sheet of material for an example Kirigami-inspired racing wheelchair;

FIG. 19 is a perspective view of the example Kirigami-inspired racing wheelchair;

FIG. 20 is a view of an example nesting pattern of parts on a sheet of material for a Kirigami-inspired wheelchair;

FIG. 21 is a perspective view of the example Kirigami-inspired wheelchair;

FIG. 22 is a perspective view of a paper prototype of a Kirigami-inspired wheelchair frame; and

FIG. 23 is a perspective view of a converted two-dimensional geometry flat part shape of the parts of the paper prototype wheelchair frame of FIG. 22.

### DETAILED DESCRIPTION

The systems and methods described herein are inspired, in part, by Kirigami, the Japanese art of cutting and folding items such as paper. The methods and systems described herein provide techniques and operational systems that may be implemented to design, fabricate, and/or manufacture devices, such as wheelchairs. The processes described herein may be based, at least in part, on cutting and forming (e.g., bending) sheet goods into three dimensional shapes that form various parts for devices, such as wheelchairs and form various types of devices, such as various styles of wheelchair frames. The systems, methods, and apparatuses described herein may allow for the design and fabrication of devices in a manner that minimizes waste while maximizing design and product flexibility and quality.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the words “include” and “comprise” and variations of the word, such as “comprising” and “comprises,” means “including but not limited to,” and is not intended to exclude other components, integers or steps. “Such as” is not used in a restrictive sense, but for explanatory purposes.

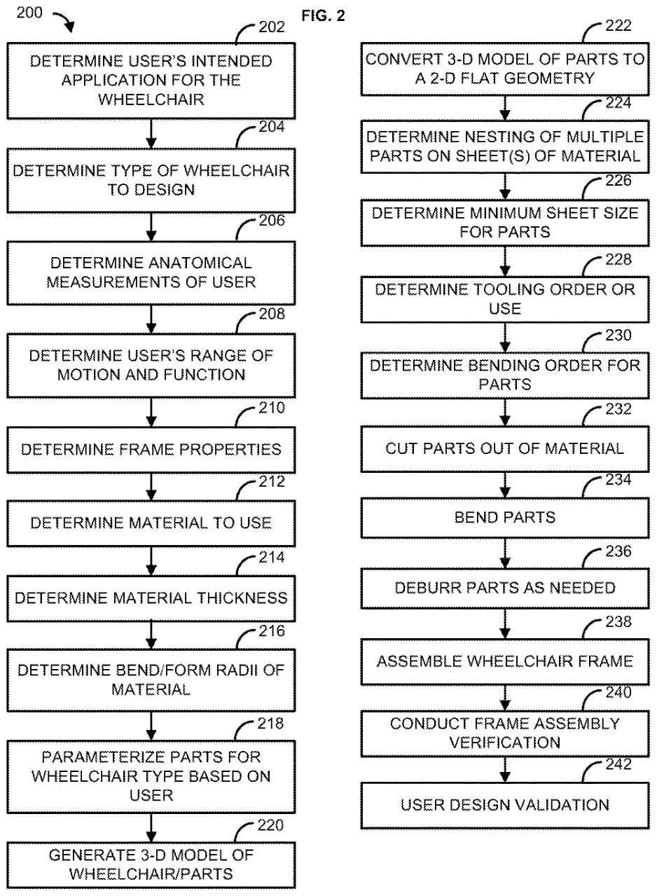

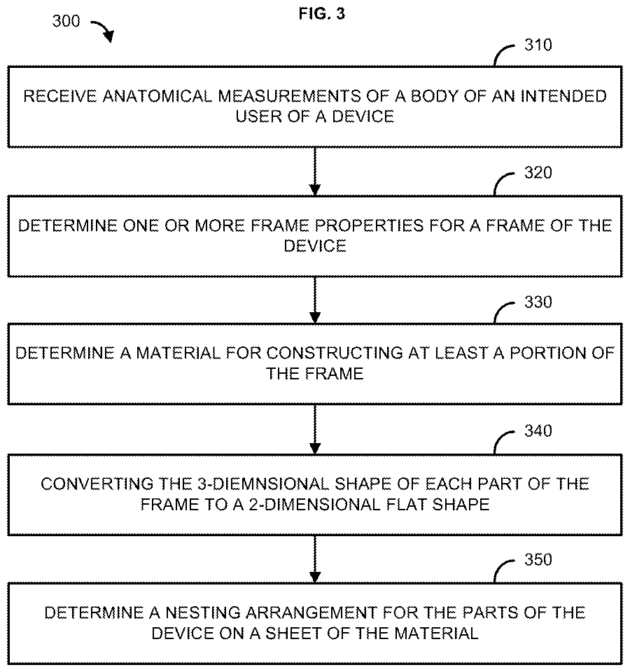

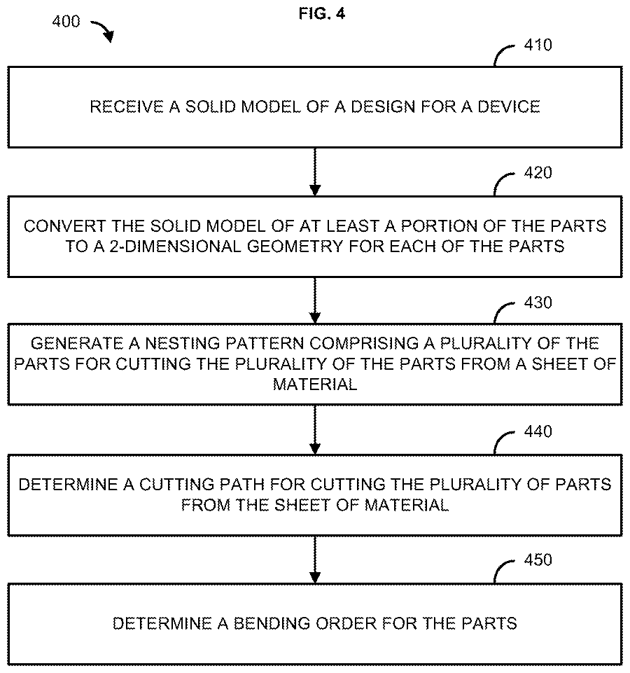

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods. As an example, the methods described with regard to FIG. 3, but not included in FIGS. 2 and 4, may also be included in FIGS. 2 and 4 in the same or additional embodiments. Similarly, the methods described with regard to FIG. 2, but not included in FIGS. 3-4, may also be included in FIGS. 3-4 in the same or additional embodiments. Similarly, the methods described with regard to FIG. 4, but not included in FIGS. 2-3, may also be included in FIGS. 2-3 in the same or additional embodiments.

As will be appreciated by one skilled in the art, hardware, software, or a combination of software and hardware may be implemented. Furthermore, a computer program product on a computer-readable storage medium (e.g., a non-transitory storage medium) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Methods, systems, and apparatuses are described herein for designing, fabricating, and manufacturing devices, such as wheelchairs. These devices may include frames or parts (e.g., components) that will be cut from a flat sheet of material and then bent one or multiple times into a desired shape or set of shapes before the part, or the device itself, is complete.

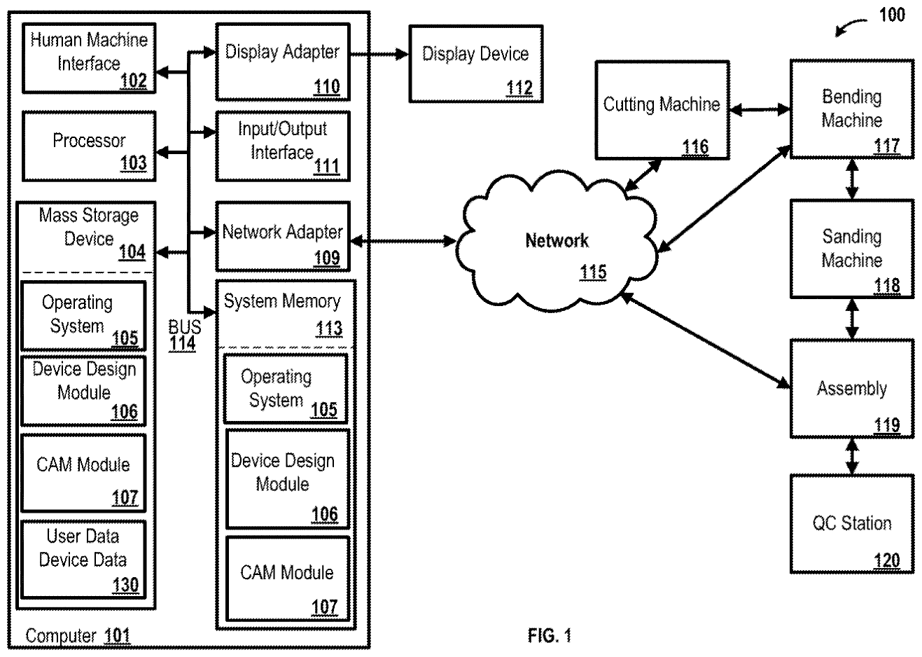

FIG. 1 shows a block diagram of an example system 100 for designing, fabricating, and/or manufacturing devices, such as wheelchairs. The system 100, may include a computer 101 (e.g., a computing device). While the example of FIG. 10 shows a single computer 101, this is for example purposes only. In other embodiments, the operations described hereinafter as being attributable to the computer 101 may be completed by multiple computers, which may be connected via a network, such as the network 115 or may be completed by a distributed computing system. For example, the computer 101 may include a plurality of servers and/or a plurality of devices that operate as a system to design, fabricate, and/or manufacture the devices, such as wheelchairs. For example, the computer 101 may comprise one or more of a server computer, a mainframe computer, a desktop computer, a laptop computer, a client device, a smart device, a mobile device (e.g., a smart phone, a tablet device, etc.), any combination thereof, or the like.

The computer 101 may include one or more processors 103, a system memory 113, and a bus 114 that couples various components of the computer 101 including the one or more processors 103 to the system memory 113. In the case of multiple processors 103, the computer 101 may utilize parallel computing or parallel processing.

The bus 114 may include one or more of several possible types of bus structures, such as a memory bus, memory controller, a peripheral bus, an accelerated graphics port, and a processor or local bus using any of a variety of bus architectures.

The computer 101 may operate on and/or include a variety of computer-readable media (e.g., non-transitory computer-readable media). Computer-readable media may be any available media that is accessible by the computer 101 and includes, non-transitory, volatile and/or non-volatile media, removable and non-removable media. The system memory 113 has computer-readable media in the form of volatile memory, such as random access memory (RAM), and/or non-volatile memory, such as read-only memory (ROM). The system memory 113 may store program modules such as an operating system 105, a device design module 106, and/or a computer-aided machining (CAM) module 107 that are accessible to and/or are operated on by the one or more processors 103.

For example, the device design module 106 may include additional modules and data for designing and fabricating devices. For example, the device and design module 106 may include computer-aided design and drafting (CAD) software for receiving and/or drafting three-dimensional representations of the device and/or each of the parts of the device. For example, the CAD software may receive or be used to create solid model, three-dimensional designs of the device (e.g., the wheelchair) and the individual parts (e.g., components) of the device. For example, the device design module 106 may include software for receiving parameterized versions of designs for the devices (e.g., wheelchairs) and modifying the parameters of the device based on particular design characteristics, such as user data. The user data may include anatomical measurements of the body of the intended user of the device, range of motion data for the intended user, and functional capabilities for the user (e.g., are they able to use both arms). For example, the anatomical measurements may include the weight of the intended user. The weight, as well as any other anatomical measurements, may be received as an input by the device design module 106, which may adjust the thickness of the seat of the device based on the weight. The adjustment of the thickness of the seat may cause other measurements of the parameterized design of the device to need to be adjusted, which the module 106 may automatically implement to customize the device (e.g., wheelchair) to the anatomical measurements, range of motion, and/or functional capabilities of the intended user of the device.

For example, the device design module 106 may include software for converting three-dimensional, solid model versions of the parts of the device into two-dimensional, pre-bent, pre-machined, representations of the parts so that the parts may be cut from a sheet of material having a desired thickness. For example, the device design module 106 may include software for organizing parts of the device in a nested pattern on material in order to reduce and/or minimize the amount of material used or the amount of material lost to waste. For example, the device and design module 106 may include software for determining an order of cutting a nested group of parts on a piece of material (e.g., a sheet of material). For example, the order of cutting the parts may include a path for cutting the parts. For example, the software may determine the order and/or pathway of cutting the nested parts that reduces and/or minimizes warpage or damage to the parts. For example, the device design module 106 may include software for determining an order for bending the parts that are to be bent as a part of the overall design of the device. For example, it may be beneficial to make some bends to certain parts or to an overall part of the device before other bends are made to the other parts or to another part of the device. This may be due to certain bending operations causing certain parts to get in the way of other parts or portions of the part that need to be subsequently bent.

For example, the CAM module 107 may include additional modules and data for creating the parts of the device. For example, the CAM module 107 may include software for organizing parts of the device in a nested pattern on material in order to reduce and/or minimize the amount of material used or the amount of material lost to waste. For example, the CAM module 107 may include software for determining an order of tool/tooling to be used when creating each of the parts of the device, For example, the CAM module 107 may include software for determining an order of cutting a nested group of parts on a piece of material (e.g., a sheet of material). For example, determining the order of cutting the parts may include determining a path for cutting the parts. For example, the software may determine the order and/or pathway of cutting the nested parts that reduces and/or minimizes warpage or damage to the parts. For example, the CAM module 107 may include software for determining an order for bending the parts that are to be bent as a part of the overall design of the device. For example, it may be beneficial to make some bends to certain parts or to an overall part of the device before other bends are made to the other parts or to another part of the device.

The computer 101 may also include other removable/non-removable, volatile/non-volatile computer storage media. The mass storage device 104 may provide non-volatile storage of computer code, computer-readable instructions, data structures, program modules, and other data for the computer 101. The mass storage device 104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 104. For example, the operating system 105, the device design module 106, and the CAM module 107 may be stored on the mass storage device 104. In addition, for example, the mass storage device 104 may include user data and device data 130 which may be made accessible to one or more of the device design module 106 and the CAM module 107. For example, the user data and device data 130 may be stored in any of one or more databases known in the art. The databases may be centralized or distributed across multiple locations within the network 115. For example, the user data and device data 130 may be input into the computer 101 by a person, may be downloaded from a storage device (e.g., a disk, compact disk, portable drive or the like), or may be received by the computer 101 from another computer via a network, such as the network 115.

For example, the user data may include, but is not limited to, anatomical measurements of one or more intended users of the devices, range of motion data for the one or more intended users and functional capability data for the one or more intended users. For example, the anatomical measurements may include a user's body mass, height, weight, torso length, hip-to-knee length, knee-to-foot length, leg length, thigh length, seated depth, seated hip width, shoulder width, arm length, spine length, back length, foot size, shoe size, or any other body measurements of the user. For example, the range of motion data may include ankle, knee, hip, shoulder, elbow, neck, and spine range of motion data. For example, the range of motion data may be scaled to a particular number, such as, for example, out of 10 or 100, or may be based on a number of degrees of motion or distance of motion of each associated joint or body area. For example, the functional abilities of the intended user may include one or more of strength, bone density, balance, active range of motion, endurance, and tissue integrity (especially in the seated area). For example, the functional ability data may be scaled to a particular number, such as, for example, out of 10 or 100.

For example, the device data may include device types, such as wheelchair types. Further, for example, for each device type there may be one or more parameterized or non-parameterized device designs (e.g., wheelchair designs) which may be selected for use based on the intended use of the device, one or more anatomical measurements of the intended user, the range of motion of one or more points of the intended user, and/or one or more functional abilities of the intended user. For example, the device may be a wheelchair and the device types may include, but are not limited to a sporting wheelchair, a daily use wheel chair, and/or a specialized wheelchair. For example, the sporting wheelchair types may include a basketball wheelchair, a tennis wheelchair, a rugby wheelchair, and/or a racing wheelchair. For example, the daily wheelchair types may include a folding wheelchair or a rigid wheelchair. For example, the specialized wheelchair types may include a standing wheelchair or a commode wheelchair.

A person may enter commands and information into the computer 101 via an input device (not shown). Such input devices include, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 103 via a human machine interface 102 that is coupled to the bus 114, but may be connected by other interface and bus structures, such as a parallel port, game port, an IEEE 1394 Port (also known as a Firewire port), a serial port, network adapter 109, and/or a universal serial bus (USB).

A display device 112 may also be connected to the bus 114 via an interface, such as a display adapter 110. It is contemplated that the computer 101 may have more than one display adapter 110 and the computer 101 may have more than one display device 112. A display device 112 may be a monitor, an LCD (Liquid Crystal Display), light-emitting diode (LED) display, television, smart lens, smart glass, and/ or a projector. In addition to the display device 112, other output peripheral devices may comprise components such as speakers (not shown) and a printer (not shown) which may be connected to the computer 101 via Input/Output Interface 111. Any step and/or result of the methods may be output (or caused to be output) in any form to an output device. Such output may be any form of visual representation, including, but not limited to, textual, graphical, animation, audio, tactile, and the like. The display device 112 and computer 101 may be part of one device, or separate devices.

The computer 101 may operate in a networked environment using logical connections to one or more other devices, such as other computing devices, a cutting machine 116, and/or a bending machine 117. For example, the cutting machine 116 may be configured to receive the two-dimensional part designs for one or more (e.g., all or less than all) of the parts for the device (e.g., the wheelchair) from the computer 101 via the network 115 or another network. For example, the cutting machine 116 may receive the two-dimensional part designs for the one or more parts as part of a nested patter of parts configured for cutting from a sheet or multiple sheets of material from the computer 101. For example, the cutting machine 116 may receive a cutting pattern or cutting path for cutting the one or more parts from the sheet of material from the computer 101. For example, the cutting machine may receive other machining and/or tooling instructions for further cutting or machining one or more of the one or more parts from the sheet or sheets of material from the computer 101. For example, the cutting machine 116 may be any one or more of a computer numerical control (CNC) router/milling machine, a laser cutting machine, a water-jet cutting machine, a plasma cutting machine and/or any other type of cutting machine known in the art. For example, the cutting machine 116 may be configured to cut the one or more parts from the sheet of material or from another form of material for the device. For example, the cutting machine 116 may be configured to cut the parts with or without human interaction and assistance.

For example, the bending machine 117 may be configured to receive the bending order and the amounts and types of bends to make for each of the one or more parts (if any bending is needed) from the computer 101 via the network 115 or another network. For example, the bending machine 117 may receive other machining and/or tooling instructions for further bending or finishing one or more of the one or more parts from the sheet or sheets of material from the computer 101. For example, the bending machine 117 may be any one or more of a (CNC) brake press machine, a manual bending station, and/or any other type of bending machine known in the art. For example, the bending machine 117 may be configured to make one or multiple bends to one or more parts of the device (e.g., wheelchair) For example, the bending machine 117 may be configured to make the bends in the parts with or without human interaction and assistance.

The system 100 may include a deburring or sanding machine 118 or station. The sanding machine or station 118 may be used to remove burrs and smooth edges on one or more of the parts of the device. The sanding machine 118 or station may be used on the parts after the cutting operation and before the bending operation or after both the cutting and bending operation are complete. The sanding machine 118 or station may include any form of sanding and/or deburring tools known in the art, including belt sanders, brush sanders, hand-held sanders, files, and/or laser-operated devices.

The system 100 may include an assembly line or station 119 and a quality control station 120. The assembly line or station may be configured to construct the device (e.g., the wheelchair from its parts). At least a portion of the parts may have been cut from one or more sheets of material. Additional parts not cut from the one or more pieces of material may also be included in the assembly of the device. These parts may include wheels, axels, cushions, foot platforms, cover material and coating, and the like. The parts may be coupled together using any known forms of coupling one part to another, including welding, riveting, screws, nails, nuts and bolts, adhesives, heat sealing, and the like. The parts may be coupled to one-another in a particular order, this particular order may be determined by the computer 101 based on the device type and the parameterized device design used for the device. The quality control station 120 may be configured to provide an area where the dimensions and specifications of the constructed device (e.g., wheelchair), or any of the individual parts, may be compared to design specifications and/or tolerances to verify that the device, or its constituent parts, are within the specification. The constructed device may be evaluated using measurement instruments known to those or ordinary skill in the art.

The system 100 may include the network 115. The network 115 may be any type of network for wireless, wired or a combination of wireless and wired transmission of data, such as a local area network (LAN) and/or a general wide area network (WAN). For example, network connections between the computer 101 and the cutting machine 116 and/or the bending machine 117 may be through a network adapter 109. A network adapter 109 may be implemented in both wired and wireless environments.

Application programs and other executable program components such as the operating system 105, the device design module 106, and the CAM module are shown herein as discrete blocks, although it is recognized that such programs and components may reside at various times in different storage components of the computer 101, and are executed by the one or more processors 103 of the computer 101. An implementation of the device design module 106 and/or the CAM module 107 may be stored on or sent across some form of computer-readable media. Any of the disclosed methods may be performed by processor-executable instructions embodied on computer-readable media.

FIG. 2 shows a flowchart of an example method 200 for creating a Kirigami-inspired wheelchair or other device. At 202, a user's intended use for the wheelchair or other device may be determined. The intended use may include how the intended user of the wheelchair or device intends to use the wheelchair or device and/or the activities that will be conducted using the wheelchair or device. For example, the intended use may be determined by the computer 101. For example, the intended use may be received by the computer 101 from another computing device or from a person as an input to the computer 101. For example, the computer 101 may receive a listing of intended activities and may determine the intended use based on the list of intended activities. For example, determining or receiving the intended use and activities for the wheelchair or device may provide a foundation for selecting from a set of device types, or if necessary, creating a new or custom design for a device type.

At 204, a type of wheelchair or other device may be determined. For example, the type of wheelchair or other device may be determined based on the intended use or activities to be completed with the wheelchair or other device. For example, the type of wheelchair or other device may be determined based on one or more anatomical measurements of the intended user, one or more ranges of motion for one or more body parts of the intended user, and/or one or more functional capabilities of the intended user. For example, the type of wheelchair or other device may be determined by the computer 101 or another computing device. For example, the computer 101 may determine the type of wheelchair or other device by receiving a selection or input indicating the type of wheelchair or other device. For example, there may be multiple device types, such as wheelchair types. Further, for example, for each device type there may be one or more parameterized or non-parameterized device designs (e.g., wheelchair designs) which may be selected for use. For example, the device may be a wheelchair and the device types may include, but are not limited to a sporting wheelchair, a daily use wheel chair, and/or a specialized wheelchair. For example, the sporting wheelchair types may include a basketball wheelchair, a tennis wheelchair, a rugby wheelchair, and/or a racing wheelchair. For example, the daily wheelchair types may include a folding wheelchair, a lightweight wheelchair, an ultralight wheelchair, or a rigid wheelchair. For example, the specialized wheelchair types may include a standing wheelchair, a shower wheelchair, or a commode wheelchair. For example, determining the correct device type to use as the base for designing and manufacturing the wheelchair may be further improved based on communication between the intended user and a design support team (e.g., physician, therapists, assistive technology professional, or the like).

For example, one or more base parameterized or non-parameterized three-dimensional solid models for each of the device types may be previously created and stored within the device types 130 of the computer 101. While there are a number of ways to create a solid model, three-dimensional version of the device (e.g., wheelchair), one will be described here for example purposes. For example, consider a device that is a wheelchair. A design of the wheelchair may be generated in the device design module 106. For example, the design may be a CAD design of the wheelchair. Having designs of the wheelchair in CAD allows for the export of geometry in file formats useful to the CAM module 107 and it allows the creation of a parameterized model for that particular design of the wheelchair. The parameterized model allows for clinically relevant dimensions (such as seat width) of the wheelchair to be entered and have all geometrically relevant dimensions automatically adjust.

The benefit of this is that device designs can be highly customized with little effort after the models are created.

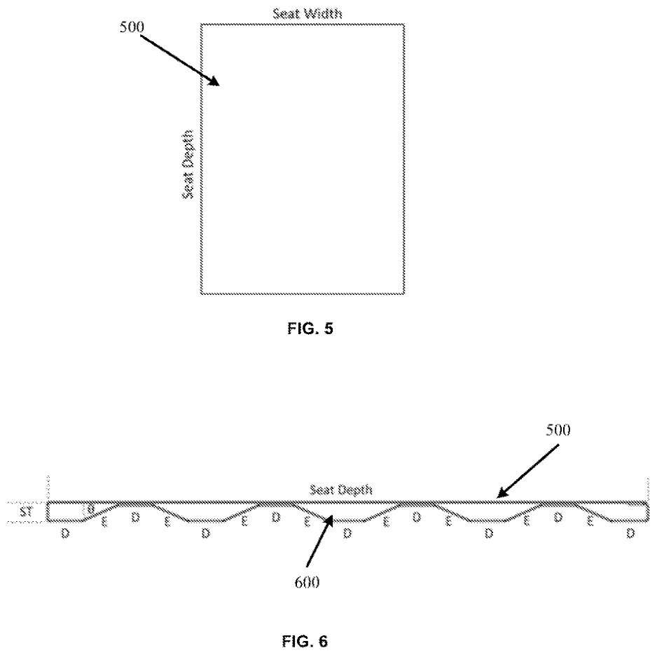

For example, a person designing the wheelchair in CAD may start with designing the seat surface 500 using a seat width and a seat depth, as shown in FIG. 5. Next a corrugated support 600 may be designed for the seat surface 500 to provide additional support. As shown in FIG. 6, one example of a design of a corrugated support 600 for the seat surface 500 may be designed. For example, variable ST may represent the seat thickness, the horizontal surface variable D for the support 600 may be determined based on D=seat depth/17; the angled surface variable E for the support 600 may be determined based on E=√(D²+ST²); and the angle Θ may be determined based on Θ=arctan(ST/D).

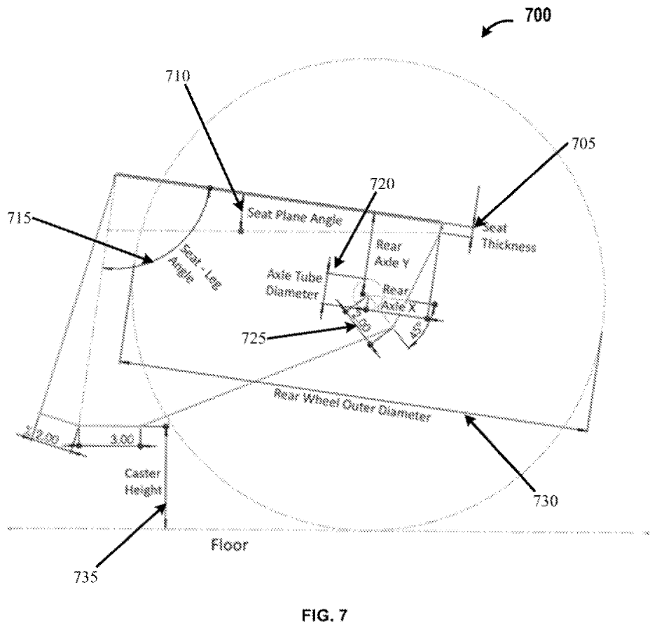

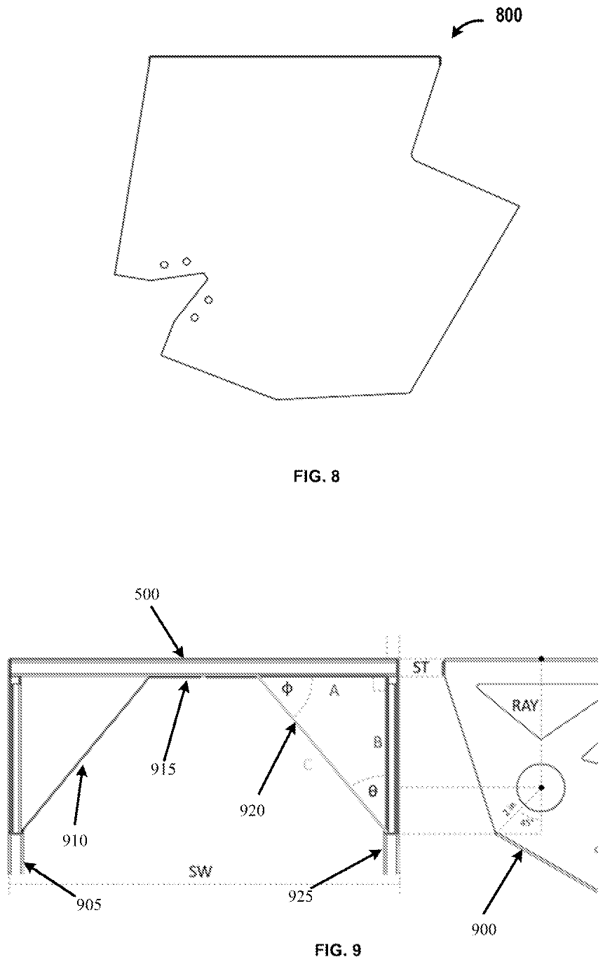

Next, a side profile of the wheelchair may be designed. As shown in FIG. 7, the side profile 700 may be designed using one or more of the seat thickness 705, seat plane angle 710, seat-leg angle 715, axle tube diameter 720, rear axle position 725, rear wheel outer diameter 730 and/or front wheel caster height 735. As shown in FIG. 8, the opposing side profile may be designed based on determining the mirror of the side profile 700 and then the resultant form 800 may be bent to form three-dimensional sides.

Next, a support structure 900 may be designed between the sides of the wheelchair 800 and the seat surface 500. As shown in FIG. 9, the support structure 900 may include a first vertical support plate 905 configured to be integrally formed with or coupled to a first side panel 800 of the wheelchair, a first angled support plate 910 configured to be integrally formed with or coupled to the first vertical support plate, one or more first horizontal support plates 915 configured to be integrally formed with or coupled to the first angled support plate 910 and coupled to a bottom side of the seat surface 500, a second angled support plate configured to be integrally formed with one of the one or more first horizontal support plates 915, and a second vertical support plate configured to be integrally formed with or coupled to a second side panel 800 of the wheelchair.

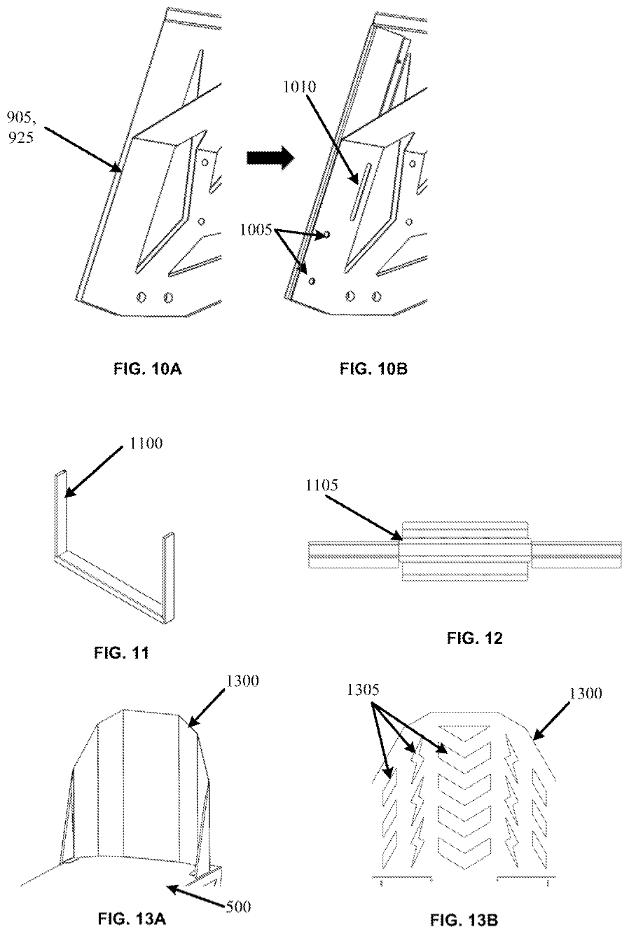

For example, the variable ST may represent seat thickness, the variable RAY may represent the rear axle position, the variable GW may represent gap width and the variable SW may represent seat width. For example, the variable distance A may be determined based on A=(SW−(2*GW))/3; the variable distance B may be determined based on B=(RAY+2*cos(45))−ST; the variable distance C may be determined based C=√(A²+B²); the variable angle Θ may be determined based on Θ=arctan(A/B); and the variable angle Φ may be determined based on Φ=90−Θ. As shown in FIGS. 10A-B, footrest sockets 1010 (e.g., an elongated slot) and apertures 1005 for footrest adjustments may be designed into the first vertical support panel 905 and the second vertical support panel 925. Next, as shown in FIGS. 11-12, the footrest 1100-1105 may be designed for the wheelchair.

A backrest 1300 may be designed for the wheelchair. For example, as shown in FIG. 13A-B, the backrest 1300 may be coupled to or integrally formed with the seat surface 500. Furthermore, in an effort to reduce the overall weight of the wheelchair, one or more openings 1305 may be cut into the backrest 1300. The openings 1305 may be designed to be cut in a predetermined pattern or set of patterns or may be designed in a random pattern. The openings 1305 may also provide a pathway for air through the backrest to cool the back of the intended user. For example, the seat surface 500, support 600, side panels 800, support structure 900, footrest 1100, and backrest 1300 may comprise the frame of the device (e.g., wheelchair). In other examples, additional or fewer components may make up the frame of the device. In certain examples, the frame parts may be flattened into a two-dimensional representation of a single integral part and cut and then bent as such. In other examples, the frame parts may be individually cut and bent as needed and then coupled to one another.

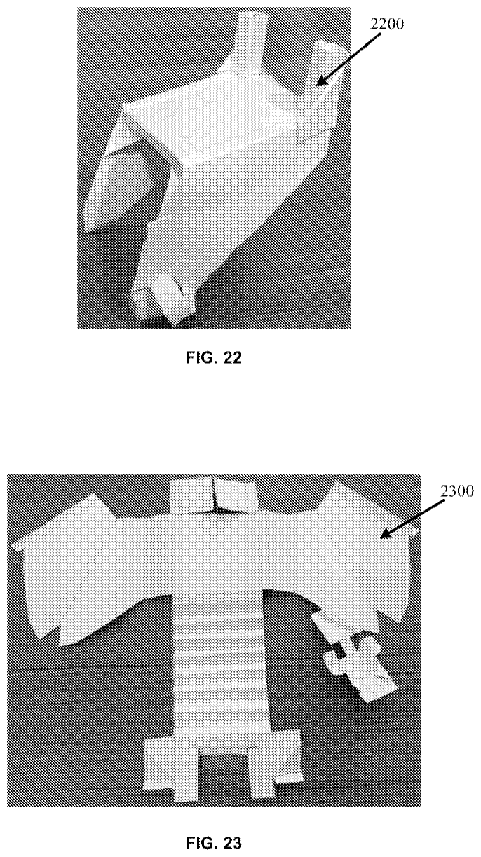

In certain examples, before three-dimensional solid model versions of the parameterized versions of the designs of the different device types are created, non-functional representations of a potential parameterized version of a device type of the device (e.g., wheelchair) or portions of the device may be created from one or more of paper, card stock, cardboard, or thin, but stiff plastic sheets as shown in FIGS. 22-23 which show an three-dimensional assembled version 2200 of the proposed device and an two-dimensional flat shape 2300 of multiple parts of the proposed device. For example, the shapes of each potential part may be cut by hand with scissors, knives, or using CNC technology, such as using a craft or vinyl cutter or low powered laser. For example, the potential design may be created in full or partial scale. For example, two-dimensional flat part shapes may be sketched onto the paper, card stock, cardboard or plastic or printed onto the paper cardboard or plastic from an initial CAD drawing. Each of the parts may be bent and shaped as desired to determine feasibility for bending parts and combining multiple bent parts into a single part to reduce the number of parts for the device. The parts, once cut and bent as desired (such as by hand) may be assembled into the desired device shape to determine if the proposed design of each part has potential to be a feasible option for the parameterized design of the device. Once each part shape, number of bends, and bend shapes have been determined, a three-dimensional solid model of the proposed parameterized design for the particular device type may be finalized.

At 206, one or more anatomical measurements of the intended user of the device (e.g., wheelchair) may be determined. For example, the one or more anatomical measurements may be received by the computer 101 from another computing device or input at the computer 101 by a person. For example, the anatomical measurements may include any one or more of the intended user's body mass, height, weight, torso length, hip-to-knee length, knee-to-foot length, leg length, thigh length, seated depth, seated hip width, shoulder width, arm length, spine length, back length, foot size, shoe size, or any other body measurements of the user. Each of the one or more anatomical measurements may be measured by a person and received as an input to the computer 101.

At 208, one or more ranges of motion and/or functional capabilities of the intended user of the device (e.g., wheelchair) may be determined. For example, the one or more ranges of motion and/or functional capabilities may be received by the computer 101 from another computing device or input at the computer 101 by a person. For example, it may be helpful to know if there are any flexible or fixed skeletal deformities of the intended user. It may also be helpful to know the range of motion of key joints of the intended user. The method described herein is configured to accommodate intended users with a wide range of skill levels from intended users with introductory skill levels intended users with advanced level skills to the point of Paralympic athletes or high levels of mobility skills (e.g., extended wheelies, curb ascent/descent, uneven terrain, etc.).

For example, the range of motion data may include ankle range of motion, knee range of motion, hip range of motion, shoulder range of motion, elbow range of motion, neck range of motion, and spine range of motion data. For example, the range of motion data may be scaled to a particular number, such as, for example, out of 10 or 100, based on some predetermined set of standards or may be based on a number of degrees of motion or distance of motion of each associated joint or body area. For example, the functional abilities of the intended user may include one or more of strength, bone density, balance, active range of motion, endurance, and tissue integrity. For example, the functional capability data may be scaled to a particular number, such as, for example, out of 10 or 100 based on a predetermined set of standards. Each of the one or more ranges of motion or functional capabilities for the intended user may be measured by a person and received as an input to the computer 101.

At 210, frame properties for the device (e.g., wheelchair) may be determined. For example, the frame properties may be determined based on one or more of the device type, one or more of the anatomical measurements of the intended user, one or more of the ranges of motion for the intended user, and/or one or more of the functional capabilities of the intended user. For example, the frame properties of the device may be determined by the computer 101. For example, the frame properties may include one or more of frame strength, thickness, durability, weight, flexibility, coupling components, and the like.

At 212, one or more materials to use for constructing the device (e.g., wheelchair) or for constructing one or more parts of the device may be determined.

For example, the materials to use may be determined by the computer 101. For example, at least a portion of the materials may be flat sheets of material from which one or more of the parts may be cut. For example, the one or more materials to use for constructing the device may be determined based on one or more of the device type, one or more of the anatomical measurements of the intended user, one or more of the ranges of motion for the intended user, one or more of the functional capabilities of the intended user, the intended activities for the device, and/or the determined frame properties. Potential materials for constructing the frame and/or other portions of the device may include metal materials, natural composites, and/or synthetic composites. For example, the metals may include steel, aluminum, titanium, or any other metal. For example, the synthetic composites may include carbon fiber, Kevlar, plastics, or any other synthetic composite. For example, the natural composites may include wood (e.g., plywood), medium density fiberboard, or any other natural composite or other material known to those of ordinary skill in the art. While material in sheet form is described herein as making many of the parts of the device, those of ordinary skill in the art will recognize that one or more other parts of the device may be made from the same or a different material and may not come from a sheet version of that particular material.

In certain examples, the type of sheet material for the design is selected to meet the needs of the intended user and activities. Various materials in sheet good form have different properties that make them more or less suitable for different device (e.g., wheelchair) designs. The properties of the sheet goods materials to be evaluated may be one or more of strength and stiffness of the materials, costs, ability to be formed (e.g., folded or bent), types of bonding feasible with the particular materials (e.g., gluing, welding, bolting, riveting), and the available finishes for the materials (e.g., painting, coating, plating, anodizing, polishing, wrapping). Different materials may be combined for sub-assemblies or portions of the device to leverage specific properties of those materials.

At 214, the thickness of the sheet material to be used to cut at least a portion of the parts of the device may be determined. For example, the thickness may be determined by the computer 101. For example, the thickness of the material may be determined based on one or more of the material type, the device type, one or more of the anatomical measurements of the intended user, one or more of the ranges of motion for the intended user, one or more of the functional capabilities of the intended user, the intended activities for the device, and/or the determined frame properties. For example, the thickness of the material may be determined based on the thickest part to be cut from that particular sheet of the material. For examples where multiple sheets of material are used to make at least a portion of the parts for the device, the thickness determined for one sheet of material may be different than the thickness for another sheet of the material.

At 216, the bend/form radii may be determined. For example, the bend/form radii may be determined by the computer 101. For example, the bend/form radii may be determined based on one or more of material type and material thickness. For example, determining the bend/form radii may include iterations based on constraints imposed (e.g. cost, wheelchair weight, durability, etc.) until the criteria are met.

At 218, the selected device design may be parameterized. For example, the selected device design may be parameterized by the computer 101. For example, the selected device design may be parameterized based on one or more of the anatomical measurements for the intended user, one or more of the ranges of motion for the intended user, and/or one or more of the functional capabilities of the intended user. For example, if the initial design of the selected device had a seat width of 16 inches but the seat width of the intended user is 19 inches, the seat width may be adjusted to 22 inches and any other dimensions that need to be adjusted, based on the adjustment to the seat width of the design, may be automatically adjusted by the computer 101. For example, the computer 101, such as the device design module 106 may be configured with processor-executable instructions on how a change in one design dimension or feature will cause changes in other design dimensions or features, such as the support design 600 of FIG. 6 or the seat depth, or the dimensions of the side panels 800 of FIG. 8, etc. For example, the computer 101 may retrieve one or more of the anatomical measurements for the intended user, one or more of the ranges of motion for the intended user, and/or one or more of the functional capabilities of the intended user and parameterize the selected design of the device (e.g., wheelchair) to customize the device design to the capabilities and measurements of the intended user. In other examples, parameterization may be skipped and the selected device design may be used as initially designed.

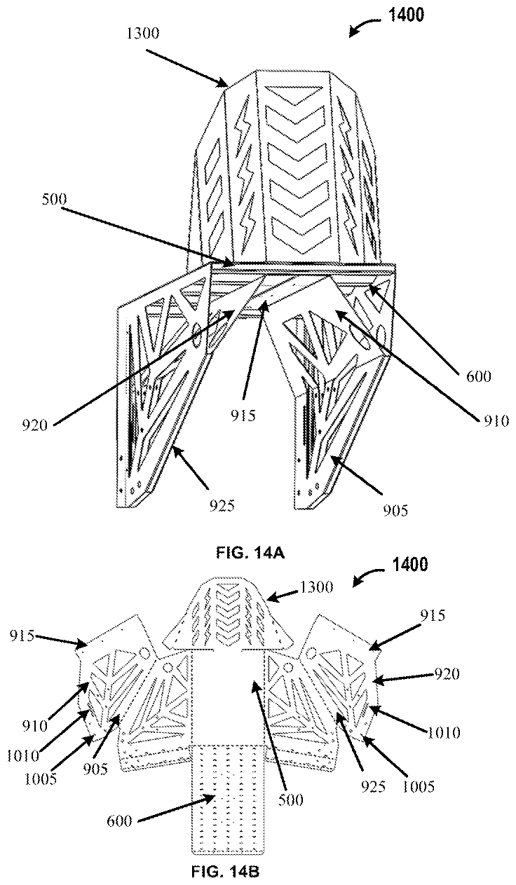

At 220, a three-dimensional solid model of the device may be generated. For example, the three-dimensional solid mode of the device may be generated by the computer 101, such as by the device design module 106. For example, the three-dimensional sold model of the device may include three-dimensional solid models of all or at least a portion of the parts (e.g., components) of the device (e.g., wheelchair). In one example, as shown in FIG. 14A, a three-dimensional solid model of a wheelchair 1400 created based on the methods described herein is shown. In addition to the device parts shown, coupling mechanisms may be determine for coupling the parts together and holes or slots for bolts or rivets may be added to the three-dimensional solid mode of the device or device frame. In another example, the holes and slots may be drilled into each part later after the parts have been cut from the sheet of material and/or bent, as needed.

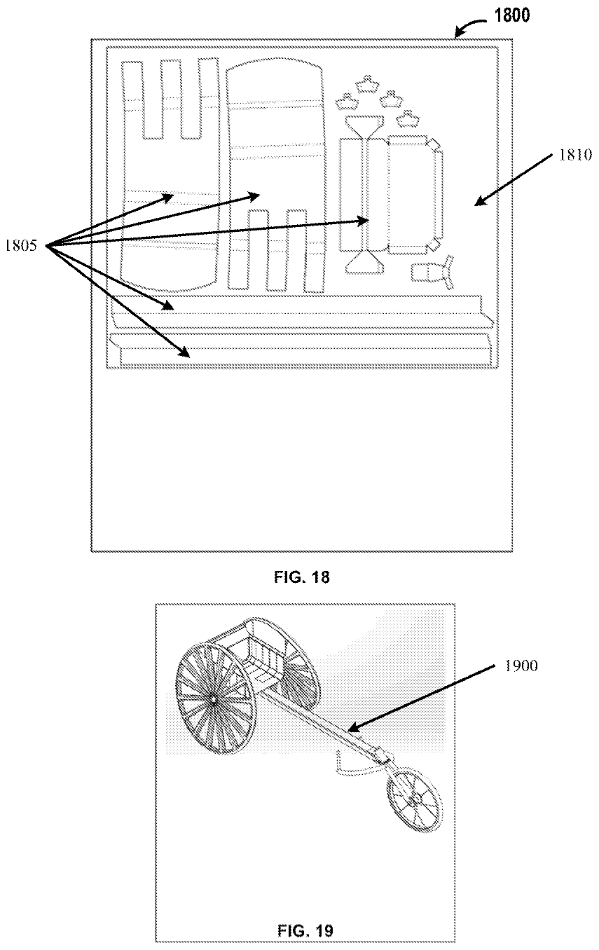

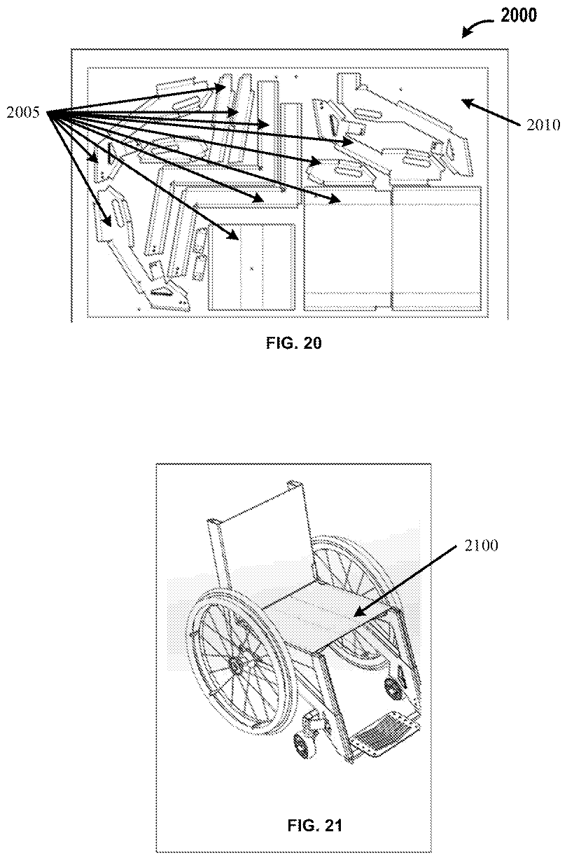

At 222, the three-dimensional solid model of the device frame or one or more parts of the device (e.g., wheelchair) may be converted into a two-dimensional flat geometry. For example, the conversion may be done by the computer 101. For example, FIG. 14B shows a two-dimensional flat part shape of the frame from the three-dimensional sold model of the frame 1400, as shown in FIG. 14A. For example, FIG. 18 shows a plurality of two-dimensional flat part shapes 1805 of a plurality of three-dimensional solid model parts of a wheelchair 1900 of FIG. 19. For example, FIG. 20 shows a plurality of two-dimensional flat part shapes 2005 of a plurality of three-dimensional solid model parts of a wheelchair 2100 of FIG. 21. For example, the two-dimensional flat geometry may be created by removing any removing any bending of the particular part and retuning it to a flat or substantially flat shape. For example, in the frame part 1400 of FIG. 14B, the two-dimensional part includes the seat surface 500, support 600, side panels 800, support structure 905-925, and backrest 1300. To generate the two-dimensional flat geometry, the bend or bends between each part of the frame 1400 have been removed and the part moved to a flat shape that can be laid over a sheet of material for cutting the frame, or plurality of parts, as shown in FIGS. 18-21, from the sheet of material. For example, the optimized three-dimensional solid model design of the frame, part, or parts of the device may be flattened and converted to a two-dimensional geometry reflected on the determined sheet goods.

At 224, a nesting pattern of the multiple parts of the device (e.g., wheelchair) on a sheet of material or on multiple sheets of material may be determined. For example, the nesting pattern may be determined by the computer 101, such as the device design module 106 or the CAM module 107. For example, the nesting pattern may be determined based on a number of iterations completed by the computer 101 to determine a nesting pattern for multiple parts that reduces and/or minimizes the amount of material used or the amount of material lost to waste. For example, in FIG. 18, a nesting pattern 1800 of a plurality of parts 1805 on a sheet of material 1810 is shown for the wheelchair 1900 of FIG. 19. For example, in FIG. 20, a nesting pattern 2000 for a plurality of parts 2005 on a sheet of material 2010 is shown for the wheelchair 2100 of FIG. 21.

At 226, a minimum sheet size (e.g., length and/or width) of the material or materials (if multiple materials and/or sheets are used) is determined. For example, the minimum sheet size may be determined by the computer 101, such as the device design module 106 or the CAM module 107. For example, the minimum sheet size may be determined based on the nesting pattern determined for the parts of the device on the sheet of the material. For example, the minimum sheet size may be determined based on the material type and/or the material thickness.

Once a nesting pattern is determined for the parts on a sheet of the material and the minimum sheet size is determined, a cutting path for cutting the parts from the sheet of material may be determined. For example, the cutting path may be determined by the computer 101, such as the device design module 106 or the CAM module 107. As part of determining the cutting path, the computer may determine an optimized cutting path based on the particular nesting pattern, part shapes, and/or minimum sheet size. For example, the optimization of the cutting path may be based on minimizing cutting time, minimizing cutting path, and/or minimizing warping or fraying (e.g., controlling temperature, order and proximity of cuts) of the parts of the device. The method of cutting, largely dependent on the type of material selected, may also influence the optimization parameters.

At 228, a tooling order and/or types of tools needed for cutting and shaping the parts of the device (e.g., wheelchair) may be determined. For example, the tooling order and/or tool types may be determined by the computer 101, such as the device design module 106 or the CAM module 107. For example, the tooling order and/or tooling type may be determined based the shape of particular parts, the nesting order of the parts, and/or the cutting path of the parts of the device.

At 230, the bending order for the parts that need to be bent prior to the device (e.g., wheelchair) being completed may be determined. For example, all or only a portion of the parts may need to be bent. For example, the bending order may be based on the difference between the three-dimensional solid model design of the part and the two-dimensional flat geometry that the part was converted to for cutting from the sheet of material. For example, the bending order may be determined by the computer 101, such as the device design module 106 or the CAM module 107. For example, the bending order may be sent from the computer 101 to the bending machine 117 via the network 115 or another network. For example, the computer 101 may be configured to maximize the bending/forming with the goal of making most of the frame of the device from a single or minimal number (e.g., sheets) and material types of sheet goods. For example parts may be combined and created from one or more tooling and/or bending operations through design, simulation, and iteration. The maximization of bent/formed components from sheet goods permits the optimization of cutting machines 116, such as CNC laser cutting, CNC cutting, or CNC routing machines. These cutting machines also provide a high degree of precision and quality with less component and product rejection than with conventional tubing based or other traditional device (e.g., wheelchair) design processes.

For example, the computer 101 may determine that some bending operations on a part or parts of the device may not be completed by the bending machine 117. For example, the bend required to be implemented on the part may not be geometrically possible using the bending machine 117 due to, for example, another portion of the part being in the way when the bend operation is attempted. For example, based on the bend operation not being able to be completed by the bending machine, the computer 101 may add perforated cuts (e.g., a perforated line of cuts) on the particular part or parts so that the bend line of the selected material will be weakened and a person may manually bend the part or parts or use another tool to facilitate the bending of the part or parts along the perforated line. Any number of perforated lines, and accordingly manual bends may be complete on a part when the bending machine 117 is unable to complete the needed bending operation.

For example, the order of the bending/forming each of the parts may be optimized primarily based on one or more of three factors: (1) the sheet material thickness and properties; (2) two-dimensional flat sheet shape of the part and the intended three-dimensional part shape; and/or (3) the type of tooling required (e.g., minimize tool changes). One or more of these three factors may be used to minimize time for bending/forming components of the device (e.g., wheelchair) cut from the sheet goods and maximize part quality (e.g., minimize rejection due to not meeting tolerances).

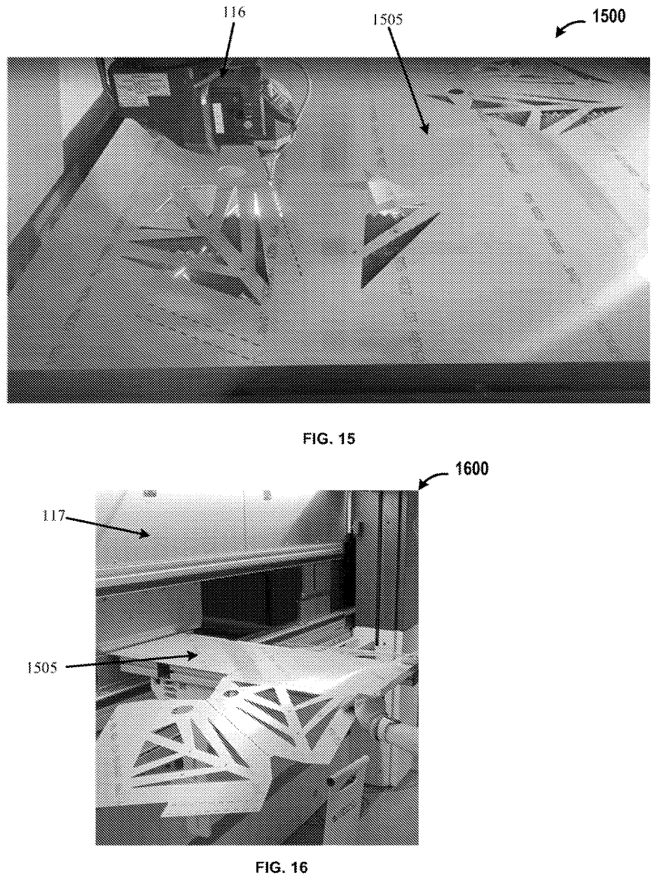

At 232, one or more parts of the device may be cut from the sheet of material. For example, the one or more parts may be cut by the cutting machine 116. For example, the computer 101 may send or transmit the nesting pattern of parts for each sheet of material, the minimum sheet size for each sheet of material, the cutting path and/or the tooling order for cutting out each part from the sheet of material to the cutting machine 116 via the network 115 or another network. For example, the cutting machine 116 may cut one or more parts of the device (e.g., wheelchair) out from the sheet of material based on one or more of the nesting pattern of parts for each sheet of material, the cutting path, and/or the tooling order for cutting out each part from the sheet of material. For example, FIG. 15 shows an example 1500 of a cutting machine 116 cutting parts from a sheet of material 1505. The cutting operation may include created perforated line cuts in the sheet of material to assist in bending the material, either by the bending machine 117 or by hand by a person.

At 234, one or more parts of the device (e.g., wheelchair) may be bent as needed to form the finished part. For example, the one or more parts may be bent by the bending machine 117. For example, the computer 101, such as the CAM module 107 may send the bending order for each part of the one or more parts of the device that need to be bent to the bending machine 117 via the network 115 or another network. For example, the bending machine 117 may bend each part that needs to be bent for the device based on the received bending order. For example, other portions of one or more parts may be hand bent by a person. For example, FIG. 16 shows an example 1600 of a bending machine 117 bending parts from a sheet of material 1505.

At 236, one or more of the cut and/or bent parts of the device (e.g., wheelchair) may be sanded and deburred. For example, the sanding an deburring of the parts may occur at the sanding machine station 118 using one or more of belt sanders, brush sanders, hand-held sanders, files, and/or laser-operated devices. In certain examples, the sanding and deburring operation may occur between the cutting operation of 232 and the bending operation of 234. The frame parts may be verified to ensure that they meet key tolerances (e.g., through use of measurements and check-jigs), and performance criteria (e.g., through sample testing of strength, durability, etc.).

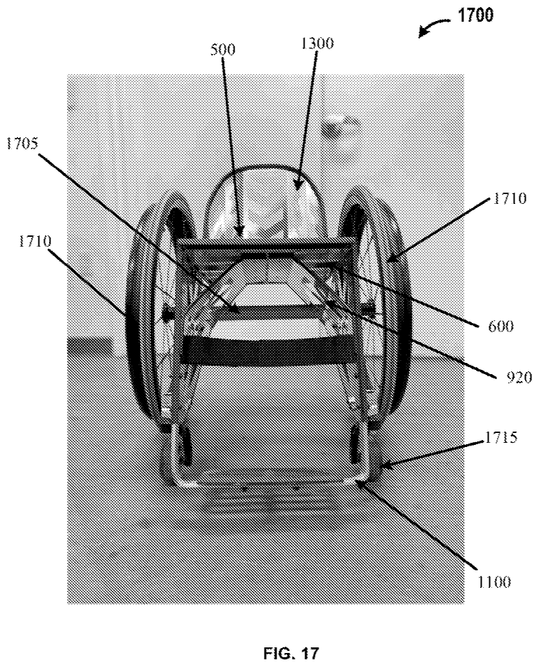

At 238, the device may be assembled from the plurality of parts cut from the sheet material and optionally from additional parts, which may not be cut from the sheet material and bent (e.g., wheels, tires, coatings, etc.). For example, the device may be assembled within an assembly area 119. For example, the assembly area 119 may include an assembly line or the like for assembling the device (e.g., wheelchair). For example, assembling the device, or the frame of the device, may be optimized to minimize assembly time (e.g., order of assembly and/or time for welding/bonding/coupling of parts), minimize need for jigs (e.g., self-aligning and/or locking parts), and minimize addition of tolerances (e.g., to avoid tolerance errors adding to exceed overall part or device tolerances). In one example, FIG. 17 shows an example assembled device 1700. For example, certain parts may have not been cut from the one or more sheets of material. For example, the device 1700 may include an axle 1705, a plurality of large wheels 1710, and a plurality of small wheels 1715, which may be separately created or sourced.

At 240, proper assembly of the device or the frame of the device may be verified. For example, the verification may be completed at a quality control station 120 or in another area. For example, the device (e.g., wheelchair) may be tested according to one or more specifications, applicable industry standards, and/or government standards. In a manufacturing production process, sample device may be created and tested using both destructive and non-destructive procedures.

At 242, the design of the device (e.g., wheelchair) may be validated by the intended user. For example, the device may be delivered to or provided to the intended user. Validation of the device may include any final fitting/adjustment of the device that may be necessary, and training as needed. If the process of creating the device results in a mismatch between the intended user expectations and the resulting device, the process can start anew at the point where the design, fabrication, or assembly of the device went awry.

FIG. 3 shows a flowchart of an example method 300 for creating a Kirigami-inspired device. For example, the device may comprise a wheelchair or another device. For example, the device may be created through the use of the computer 101 and/or other devices. At 310, one or more anatomical measurements of an intended user of the device may be received. For example, the one or more anatomical measurements may be received by the computer 101 from another computing device or input at the computer 101 by a person. For example, the anatomical measurements may include any one or more of the intended user's body mass, height, weight, torso length, hip-to-knee length, knee-to-foot length, leg length, thigh length, seated depth, seated hip width, shoulder width, arm length, spine length, back length, foot size, shoe size, or any other body measurements of the user. Each of the one or more anatomical measurements may be measured by a person and received as an input to the computer 101.

In certain examples, additional information associated with the intended user may also be used. For example, certain additional information associated with the intended user may be received by the computer 101. For example, one or more ranges of motion and/or functional capabilities of the intended user of the device (e.g., wheelchair) may be received. For example, the one or more ranges of motion and/or functional capabilities may be received by the computer 101. For example, the range of motion data may include ankle range of motion, knee range of motion, hip range of motion, shoulder range of motion, elbow range of motion, neck range of motion, and spine range of motion data. For example, the range of motion data may be scaled to a particular number, such as, for example, out of 10 or 100, based on some predetermined set of standards or may be based on a number of degrees of motion or distance of motion of each associated joint or body area. For example, the functional abilities of the intended user may include one or more of strength, bone density, balance, active range of motion, endurance, and tissue integrity. For example, the functional capability data may be scaled to a particular number, such as, for example, out of 10 or 100 based on a predetermined set of standards.

Additional information may also be received related to the user. For example, information may be received related to the intended use or application of the device (e.g., wheelchair) by the intended user. The intended use data may include how the intended user of the device intends to use the device and/or the activities that will be conducted using the device. For example, the intended use data may be received by the computer 101 from another computing device or from a person as an input to the computer 101. For example, the computer 101 may receive a listing of intended activities and may determine the intended use based on the list of intended activities. For example, determining or receiving the intended use and activities for the wheelchair or device may provide a foundation for selecting from a set of device types (e.g., wheelchair types), or if necessary, creating a new or custom design for a device type.

At 320, one or more properties for a frame of the device may be determined. For example, the one or more properties may be determined by the computer 101. For example, the one or more properties may include one or more of frame strength, thickness, durability, weight, flexibility, coupling components, and the like. For example, the one or more properties may be determined based on the one or more anatomical measurements of the intended user. In certain examples, the one or more properties may be determined based on one or more of one or more of the anatomical measurements of the intended user, one or more of the ranges of motion for the intended user, and/or one or more of the functional capabilities of the intended user.

For example, the one or more properties may further be determined based on device type (e.g., wheelchair type). For example, the device type may be received by the computer 101 from another computing device or as an input by a person. For example, there may be multiple device types, such as wheelchair types. Further, for example, for each device type there may be one or more parameterized or non-parameterized device designs (e.g., wheelchair designs) which may be selected for use. In examples where the device is a wheelchair, the device types may include, but are not limited to a sporting wheelchair, a daily use wheel chair, and/or a specialized wheelchair. For example, the sporting wheelchair types may include further device types, such as a basketball wheelchair, a tennis wheelchair, a rugby wheelchair, and/or a racing wheelchair. For example, the daily wheelchair types may further include additional device types, such as a folding wheelchair, a lightweight wheelchair, an ultralight wheelchair, or a rigid wheelchair. For example, the specialized wheelchair types may further include additional device types, such as a standing wheelchair, a shower wheelchair, or a commode wheelchair.

At 330, a material for constructing at least a portion of the frame of the device may be determined. For example, the material may be determined by the computer 101. For example, the material may be used to construct a plurality of parts for at least a portion of the frame of the device (e.g., wheelchair). For example, the material may be a sheet of the material having a predetermined thickness. For example, more than one material type and/or material thickness may be determined to be used for constructing the plurality of the parts for all or a portion of the frame. For example, the material may be determined based on the one or more frame properties. For example, the material to use may be further determined based on the intended use of the device. For example, the material to use may be determined based on one or more of the device type, one or more of the anatomical measurements of the intended user, one or more of the ranges of motion for the intended user, one or more of the functional capabilities of the intended user, the intended activities for the device, and/or the determined frame properties.

For example, potential materials for constructing the frame and/or other portions of the device may include metal materials, natural composites, and/or synthetic composites. For example, the metals may include steel, aluminum, titanium, or any other metal. For example, the synthetic composites may include carbon fiber, Kevlar, plastic, or any other synthetic composite. For example, the natural composites may include wood (e.g., plywood), medium density fiberboard, or any other natural composite or other material known to those of ordinary skill in the art. While material in sheet form is described herein as making many of the parts of the device, those of ordinary skill in the art will recognize that one or more other parts of the device may be made from the same or a different material and may not come from a sheet version of that particular material. In addition to material type, other information about the material may be determined such as material thickness and the bend/form radii of the material as described in 214 and 216 of FIG. 2.

The frame of the device or one or more parts of the frame of the device (e.g., wheelchair) may be parameterized based on data associated with the intended user as described in 218 of FIG. 2. For example, a parameterized design for the device and/or the frame of the device may be determined by the computer 101 based on one or more anatomical measurements of the intended user. For example, in parameterizing the design of the device, one or more dimensions of the parameterized design and/or structural requirements of the parameterized design may be modified based on one or more of the anatomical measurements of the intended user. Based on the parameterized design, a three-dimensional solid model of the device may be created or generated by the computer 101. For example, the three-dimensional solid model of the device may include three-dimensional solid model designs or shapes of each part of the device and/or the device frame.

At 340, a three-dimensional shape for one or more parts of the device frame (and optionally other additional parts of the device) may be converted into a two-dimensional flat part shape configured to be overlaid on a sheet of material having a desired thickness for cutting the part from the sheet of material. For example, the one or more parts of the device frame may be converted to two-dimensional flat part shapes by the computer 101. For example, the computer 101 may determine the two-dimensional flat part shape of each part based at least one the one or more bending operations needed to modify the two-dimensional flat part shape into the desired three-dimensional shape for each respective part.

At 350, a nesting arrangement or pattern for the one or more parts of the device frame may be determined on a sheet of the material. For example, the nesting arrangement may be determined by the computer 101. For example, the nesting arrangement for the one or more parts may be set out across multiple sheets of material. For example, the nesting arrangement may be determined based on a number of iterations completed by the computer 101 to determine a nesting arrangement for multiple parts that reduces and/or minimizes the amount of material used or the amount of material lost to waste. Examples of nesting arrangements are provided in FIGS. 18 and 20, as discussed above. For example, the nesting arrangement may be determined based on one or more of the size and two-dimensional flat shape of each of the parts, the cutting capabilities of the cutting machine 116, and the space needed between each part to limit warpage or damage during the cutting process. The nesting arrangement for each sheet of material for the parts of the device may be subsequently sent or transmitted from the computer 101 to the cutting machine 116 via the network 115 or another network.

In addition to determining the nesting arrangement, other information may be determined by the computer 101. For example, the cutting path to be used by the cutting device 116 to cut the parts from the sheet of material may be determined. For example, the computer 101 may determine an optimized cutting path based on the particular nesting pattern, two-dimensional flat part shapes, and/or a minimum sheet size for the material used to create the parts. For example, the minimum sheet size for the material may be determined as described at 226 of FIG. 2. For example, the optimization of the cutting path may be based on minimizing cutting time, minimizing cutting path, and/or minimizing warping or fraying (e.g., controlling temperature, order and proximity of cuts) of the parts of the device.

In addition, a bending order for bending one or more parts cut from the sheet of material may be determined. For example, all or only a portion of the parts for the frame of the device (e.g., wheelchair) or for the device may need to be bent. For example, the bending order may be based on the difference between the three-dimensional solid model design of the part and the two-dimensional flat part shape that the part was converted to for cutting from the sheet of material. For example, the bending order may be determined by the computer 101. For example, the computer 101 may be configured to maximize the bending/forming with the goal of making most of the frame of the device from a single or minimal number (e.g., sheets) and material types of sheet goods. For example parts may be combined and created from one or more tooling and/or bending operations through design, simulation, and iteration.

For example, the order of the bending/forming each of the parts may be optimized primarily based on one or more of three factors: (1) the sheet material thickness and properties; (2) two-dimensional flat sheet shape of the part and the intended three-dimensional part shape; and/or (3) the type of tooling required (e.g., minimize tool changes). One or more of these three factors may be used to minimize time for bending/forming components of the device (e.g., wheelchair) cut from the sheet of material and maximize part quality (e.g., minimize rejection due to not meeting tolerances). For example, the bending order may be sent from the computer 101 to the bending machine 117 via the network 115 or another network.

For example, the computer 101 may determine that some bending operations on a part or parts of the device may not be completed by the bending machine 117. For example, the bend required to be implemented on the part may not be geometrically possible using the bending machine 117 due to, for example, another portion of the part being in the way when the bend operation is attempted. For example, based on the bend operation not being able to be completed by the bending machine, the computer 101 may add perforated cuts (e.g., a perforated line of cuts) on the particular part or parts so that the bend line of the selected material will be weakened and a person may manually bend the part or parts or use another tool to facilitate the bending of the part or parts along the perforated line. Any number of perforated lines, and accordingly manual bends may be complete on a part when the bending machine 117 is unable to complete the needed bending operation.

For example, one or more parts of the device (e.g., wheelchair) may be cut from the sheet of material. For example, the one or more parts may be cut at the cutting machine 116. For example, the one or more parts may be cut from the sheet of material based on the determined cutting pattern. The one or more parts may be bent, as needed to achieve the desired three-dimensional solid model shape. For example, the one or more parts may be bent at the bending machine 117. For example, the one or more parts may be bent based on the determined bending order. The device may be assembled or constructed from the one or more parts and from additional parts that may have not been cut from the sheet of material (e.g., wheels, rubberized covers, seat pads, coatings, etc.).

In certain examples, before three-dimensional solid model versions of the parameterized versions of the designs of the different device types are created, non-functional representations of a potential parameterized version of a device type of the device (e.g., wheelchair) or portions of the device may be created from one or more of paper, card stock, cardboard, or thin, but stiff plastic sheets. For example, the shapes of each potential part may be cut by hand with scissors, knives, or using CNC technology, such as using a craft or vinyl cutter or low powered laser. For example, the potential design may be created in full or partial scale. For example, two-dimensional flat part shapes may be sketched onto the paper, card stock, cardboard or plastic or printed onto the paper cardboard or plastic from an initial CAD drawing.

Each of the parts may be bent and shaped as desired to determine feasibility for bending parts and combining multiple bent parts into a single part to reduce the number of parts for the device. The parts, once cut and bent as desired (such as by hand) may be assembled into the desired device shape to determine if the proposed design of each part has potential to be a feasible option for the parameterized design of the device. Once each part shape, number of bends, and bend shapes have been determined, a three-dimensional solid model of the proposed parameterized design for the particular device type may be finalized.

FIG. 4 shows a flowchart of an example method 400 for creating a Kirigami-inspired device. For example, the device may comprise a wheelchair or another device. For example, the device may be created through the use of the computer 101 and/or other devices. In certain examples, certain information associated with the intended user of the device may be determined for selecting, designing, and/or modifying the design of the device. For example, an intended use of the device by the intended user may be received or determined by the computer 101 as described at 202 of FIG. 2, a design type for the device may be received or determined by the computer 101 as described at 204, and anatomical measurements, range of motion and/or functional capabilities of the intended user may be received or determined by the computer 101 as described at 206-208. Further, in certain examples, frame properties for the device, material type for creating one or more parts of the device, material thickness, and bend/form radii may be determined by the computer 101 as described in 210-216 of FIG. 2. Further, in certain examples, a design of the device may be parameterized by the computer 101 based on certain factors as described at 218 of FIG. 2.

At 410, a solid model of a design of a device may be received. For example, the solid model may be a three-dimensional solid model of the device (e.g., wheelchair). For example, the solid model may be received by the computer 101 from another computing device or input at the computer 101 by a person. For example, the solid model of the device may be a parameterized design of the device. For example, at least one dimension of the device has been modified based on the parameterization, which may be based on data associated with the intended user of the device. For example, receiving the solid model of the device comprises receiving three-dimensional solid model designs of all or at least a portion of the parts of the device.

At 420, the solid model for one or more parts of the device (e.g. parts of the device frame and optionally other additional parts of the device) may be converted into a two-dimensional geometry. For example, the two-dimensional geometry of each part may be configured to be overlaid on a sheet of material having a desired thickness for cutting the part from the sheet of material. For example, the one or more parts of the device frame may be converted to the two-dimensional geometry by the computer 101. For example, the computer 101 may determine the two-dimensional geometry of each part based at least one the one or more bending operations needed to modify the part from the two-dimensional geometry into the desired three-dimensional shape for each respective part.

At 430, a nesting pattern for a plurality of parts of the device may be determined on a sheet of the material. For example, the nesting pattern may be determined by the computer 101. For example, the nesting pattern may be determined on the sheet of material for cutting the plurality of parts from the sheet of material. For example, the nesting pattern for the plurality of parts may be set out across multiple sheets of material having the same or different thicknesses and/or material types. For example, the nesting pattern may be determined based on a number of iterations completed by the computer 101 to determine a nesting pattern for multiple parts that reduces and/or minimizes the amount of material used or the amount of material lost to waste. Examples of nesting patterns are provided in FIGS. 18 and 20, as discussed above. For example, the nesting pattern may be determined based on one or more of the size and two-dimensional flat shape of each of the plurality of parts, the cutting capabilities of the cutting machine 116, and the space needed between each part to limit warpage or damage during the cutting process. The nesting pattern for each sheet of material for the plurality of parts of the device may be subsequently sent or transmitted from the computer 101 to the cutting machine 116 via the network 115 or another network.

At 440, a cutting path to be used by the cutting device 116 to cut the plurality of parts from the sheet of material may be determined. For example, the cutting path may be determined by the computer 101. For example, the computer 101 may determine an optimized cutting path based on the particular nesting pattern, two-dimensional flat part shapes, and/or a minimum sheet size for the material used to create the parts. For example, the optimization of the cutting path may be based on minimizing cutting time, minimizing cutting path, and/or minimizing warping or fraying (e.g., controlling temperature, order and proximity of cuts) of the parts of the device. For example, the cutting path determined may minimize one or more of warpage to a part of the plurality of parts or damage to the part of the plurality of parts.

At 450, a bending order for bending one or more parts cut from the sheet of material may be determined. For example, all or only a portion of the parts for the frame of the device (e.g., wheelchair) or for the device may need to be bent. For example, the bending order may be based on the difference between the three-dimensional solid model design of the part and the two-dimensional flat part shape that the part was converted to for cutting from the sheet of material. For example, the bending order may be determined by the computer 101. For example, the computer 101 may be configured to maximize the bending/forming with the goal of making most of the frame of the device from a single or minimal number (e.g., sheets) and material types of sheet goods. For example parts may be combined and created from one or more tooling and/or bending operations through design, simulation, and iteration.

For example, the order of the bending/forming each of the parts may be optimized primarily based on one or more of three factors: (1) the sheet material thickness and properties; (2) two-dimensional flat sheet shape of the part and the intended three-dimensional part shape; and/or (3) the type of tooling required (e.g., minimize tool changes). One or more of these three factors may be used to minimize time for bending/forming components of the device (e.g., wheelchair) cut from the sheet of material and maximize part quality (e.g., minimize rejection due to not meeting tolerances). For example, the bending order may be sent from the computer 101 to the bending machine 117 via the network 115 or another network.

For example, the computer 101 may determine that some bending operations on a part or parts of the device may not be completed by the bending machine 117. For example, the bend required to be implemented on the part may not be geometrically possible using the bending machine 117 due to, for example, another portion of the part being in the way when the bend operation is attempted. For example, based on the bend operation not being able to be completed by the bending machine, the computer 101 may add perforated cuts (e.g., a perforated line of cuts) on the particular part or parts so that the bend line of the selected material will be weakened and a person may manually bend the part or parts or use another tool to facilitate the bending of the part or parts along the perforated line. Any number of perforated lines, and accordingly manual bends may be complete on a part when the bending machine 117 is unable to complete the needed bending operation.

For example, one or more parts of the device (e.g., wheelchair) may be cut from the sheet of material. For example, the one or more parts may be cut at the cutting machine 116. For example, the one or more parts may be cut from the sheet of material based on the determined cutting pattern. The one or more parts may be bent, as needed to achieve the desired three-dimensional solid model shape. For example, the one or more parts may be bent at the bending machine 117. For example, the one or more parts may be bent based on the determined bending order.

The device may be assembled or constructed from the plurality of parts and from additional parts that may have not been cut from the sheet of material (e.g., wheels, rubberized covers, seat pads, coatings, etc.). For example, assembling the device, or the frame of the device, may be optimized to minimize assembly time (e.g., order of assembly and/or time for welding/bonding/coupling of parts), minimize need for jigs (e.g., self-aligning and/or locking parts), and minimize addition of tolerances (e.g., to avoid tolerance errors adding to exceed overall part or device tolerances). For example, the computer 101 may determine a coupling order or assembly order for coupling the plurality of parts and for also coupling any of the additional parts that were not cut from the sheet of material. For example, the computer may determine the coupling order for coupling the parts of the device based on the parameterized design of the device. For example, the parts may be coupled to one-another in an order determined by the computer 101 based on the device type and the parameterized device design used for the device (e.g., wheelchair).

For example, the computer 101 may also determine coupling methods, materials, and/or techniques to be used for coupling each of the parts of the device together. The parts may be coupled together using any known forms of coupling one part to another, including welding, riveting, screws, nails, nuts and bolts, adhesives, heat sealing, and the like. For example, the coupling methods, materials, and/or techniques may be determined based on one or more of the part shapes, the load expected on the particular parts, the intended use of the particular parts, the intended use of the device, the device type, the material of the parts, and/or the frame properties. The device (e.g., wheelchair) may then be assembled based on the determined coupling order and the determined coupling methods, materials, and/or techniques.

In certain examples, before three-dimensional solid model versions of the parameterized versions of the designs of the different device types are created, non-functional representations of a potential parameterized version of a device type of the device (e.g., wheelchair) or portions of the device may be created from one or more of paper, card stock, cardboard, or thin, but stiff plastic sheets. For example, the shapes of each potential part may be cut by hand with scissors, knives, or using CNC technology, such as using a craft or vinyl cutter or low powered laser. For example, the potential design may be created in full or partial scale. For example, two-dimensional flat part shapes may be sketched onto the paper, card stock, cardboard or plastic or printed onto the paper cardboard or plastic from an initial CAD drawing. Each of the parts may be bent and shaped as desired to determine feasibility for bending parts and combining multiple bent parts into a single part to reduce the number of parts for the device. The parts, once cut and bent as desired (such as by hand) may be assembled into the desired device shape to determine if the proposed design of each part has potential to be a feasible option for the parameterized design of the device. Once each part shape, number of bends, and bend shapes have been determined, a three-dimensional solid model of the proposed parameterized design for the particular device type may be finalized.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
receiving, by a computing device, one or more anatomical measurements of a body of an intended user of a device;
determining, by the computing device and based on the one or more anatomical measurements, one or more frame properties for a frame of the device;
determining, by the computing device and based on the one or more frame properties, a material for constructing a plurality of parts for at least a portion of the frame of the device;
converting, by the computing device, a three-dimensional shape for each part of the portion of the plurality of parts into a two-dimensional flat part shape;
determining, by the computing device and based on the two-dimensional flat part shape for each part of the portion of the plurality of parts, a nesting arrangement for a plurality of the portion of the plurality of parts on a sheet of the material.

2. The method of claim 1, further comprising determining, based on the one or more anatomical measurements, a parameterized design for the device.

3. The method of claim 2, further comprising modifying, based on at least one of the one or more anatomical measurements, at least one dimension of the parameterized design for the device.

4. The method of claim 1, further comprising receiving an indication of an intended use for the device, wherein the material for constructing the plurality of parts is further determined based on the intended use of the device.

5. The method of claim 1, further comprising, determining the two-dimensional flat part shape for each part based on the one or more bending operations needed to modify the two-dimensional flat part shape into the three-dimensional shape for each part.

6. The method of claim 1, further comprising sending the nesting arrangement to a cutting machine configured to cut the plurality of the portion of the plurality of parts out of the sheet of the material.

7. The method of claim 1, further comprising:
cutting the plurality of the portion of the plurality of parts out of the sheet of material; and
constructing the device from the plurality of parts.

8. The method of claim 1, further comprising determining a bending order for bending at least one part of the portion of the plurality of parts.

9. The method of claim 1, further comprising:
constructing a paper prototype of the device; and
determining, based on the paper prototype, a feasibility for one or more of a design of the device or bending at least one part of the portion of the plurality of parts of the device.

10. The method of claim 9, wherein the paper prototype is constructed of one or more of paper, card stock, or cardboard.

11. The method of claim 1, wherein the device comprises a wheelchair.

12. A method comprising:
receiving, by a computing device, a solid model of a parameterized design for a device;
converting, by the computing device, a solid model design of at least a portion of the parts of the device to a two-dimensional geometry for each of the at least the portion of the parts;
generating, by the computing device, a nesting pattern comprising a plurality of the at least the portion of the parts for cutting the plurality of the at least the portion of the parts from a sheet of material;
determining, by the computing device, a cutting path for cutting the plurality of the at least the portion of the parts from the sheet of material, wherein the cutting path minimizes one or more of warpage to a part of the plurality of the at least the portion of the parts or damage to the part of the plurality of the at least the portion of the parts; and
determining, by the computing device, a bending order for one or more parts of the at least the portion of the parts.

13. The method of claim 12, wherein the device comprises a wheelchair.

14. The method of claim 12, wherein receiving the solid model of the parameterized design for the device comprises receiving a solid model of the at least the portion of the parts of the device.

15. The method of claim 12, further comprising determining coupling methods for coupling the at least the portion of the parts of the device.

16. The method of claim 12, further comprising determining a coupling order for coupling the at least the portion of the parts of the device.

17. One or more non-transitory computer-readable media storing processor-executable instructions that, when executed by at least one processor, cause the at least one processor to:
receive one or more anatomical measurements of a body of an intended user of a device;
determine, based on the one or more anatomical measurements, one or more frame properties for a frame of the device;
determine, based on the one or more frame properties, a material for constructing a plurality of parts for at least a portion of the frame of the device;
convert a three-dimensional shape for each part of the portion of the plurality of parts into a two-dimensional flat part shape;
determine, based on the two-dimensional flat part shape for each part of the portion of the plurality of parts, a nesting arrangement for a plurality of the portion of the plurality of parts on a sheet of the material.

18. The one or more non-transitory computer-readable media of claim 17, wherein the processor-executable instructions, when executed by the at least one processor, further cause the at least one processor to determine, based on the one or more anatomical measurements, a parameterized design for the device.

19. The one or more non-transitory computer-readable media of claim 17, wherein the processor-executable instructions, when executed by the at least one processor, further cause the at least one processor to determine the two-dimensional flat part shape for each part based on the one or more bending operations needed to modify the two-dimensional flat part shape into the three-dimensional shape for each part.

20. The one or more non-transitory computer-readable media of claim 17, wherein the device comprises a wheelchair.
